(19) United States
(12) Patent Application Publication
(10) Pub. No.: US 2010/0018609 A1
(43) Pub. Date: Jan. 28, 2010

(54) Power Tool

(75) Inventors: Benjamin Luke Van Der Linde, Narre Warren South (AU); David Leigh Scrimshaw, Beaumaris (AU); Paul Davies, Belgrave (AU); Paul Miller, Upwey (AU); Paul Francis Connor, Elwood (AU)

Correspondence Address: AKERMAN SENTERFITT, P.O. BOX 3188, WEST PALM BEACH, FL, 33402-3188, US

(73) Assignee: DEMAIN TECHNOLOGY PTY LTD., Braeside, Victoria (AU)

(21) Appl. No.: 12/298,555

(22) PCT Filed: Apr. 26, 2007
(86) PCT No.: PCT/AU2007/000541

§ 371 Date: Dec. 31, 2008

(30) Foreign Application Priority Data
Apr. 26, 2006 (AU) 2006902156

(51) Int. Cl. B27C 5/10; B25F 5/00

(52) U.S. Cl. 144/136.95; 409/182; 409/206; 700/168

(57) ABSTRACT

The invention relates to a hand held power tool, such as a router, for use with an operative element to treat a work piece over a treatment depth from a face of the work piece. The power tool includes a base positionable in use adjacent the work piece and a fastening assembly for holding the operative element, the fastening assembly being rotatable about an operative axis and being movable relative to the base in the direction of the operative axis. The power tool also includes primary power drive means including a motor being operable to rotate the fastening assembly about the operative axis and secondary power drive means including a motor being operable to move the fastening assembly relative to the base in the direction of the operative axis.; Further included in the power tool is an electronic control means for controlling at least the operation of the secondary power drive means, the electronic control means having associated user controls, and at least one handle which is held by the user while operating the power tool. The user controls are located on the at least one handle to enable user operation of the secondary power drive means while holding the at least one handle.

### BACKGROUND OF THE INVENTION

1. Field of the Invention

This invention relates to a hand held power tool having an operative element for treating the face of a work piece. The power tool is of the kind that has a base positionable in use adjacent a work piece, an operative element that is rotatable about an axis, whereby the operative element is also movable in the direction of the axis relative to the base to treat the work piece. One form of power tool to which the invention applies is a router, and it will be convenient to hereinafter describe the invention with reference to this form of power tool. It should however be appreciated that the invention is not limited to that application and can apply to other forms of power tools.

2. Description of the Prior Art

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Plunging type routers are one form of power tool used to cut shapes into wooden, plastic or metal work pieces. These types of routers include an electric motor having an output shaft on which a cutting tool for treating the surface of a work piece is attached. The electric motor is typically enclosed within a housing which includes substantially all of the controls and componentry of the router. The housing is movably mounted on one or more columns extending from a base plate which supports the housing above the work piece. The router can be moved over the surface of the work piece using one or more handles attached to the housing of the router.

A user operates the router by gripping the handles, positioning the base plate over the desired portion of the work piece, turning the motor on using the controls on the housing and then lowering the housing and cutting tool along the columns to plunge the operative element past the base plate into the work piece. Stops are normally provided on the columns to limit the depth of the plunge to a selected depth.

The operation of such a router requires a high degree of skill in order to successfully position, plunge and control the apparatus in a single action. In this regard, appreciating the face of the work piece, depth of plunge required, lowering speed of the cutting tool and correct setting of the position of the stops can be difficult to determine manually. Furthermore, due to the configuration of the housing and handles, the cutting tool can be obscured by the bulk of the motor housing during operation when the operator views the work piece and router from above. This makes it difficult guiding the cutting tool in the horizontal plane, which can lead to the cutting tool plunging in the wrong location.

It would therefore be desirable to provide a power tool that is relatively easy to use. It would be preferred that the power tool be designed to make the plunging operation of the tool easier to control during operation of the tool. It may also be preferred that the power tool provides improved vision of the operative element when in use.

### SUMMARY OF THE INVENTION

According to one aspect of this invention there is provided a hand held power tool for use with an operative element to treat a work piece over a treatment depth from a face of the work piece, the power tool including:

a base positionable in use adjacent the work piece;

a fastening assembly for holding the operative element, the fastening assembly being rotatable about an operative axis, the fastening assembly being movable relative to the base in the direction of the operative axis;

primary power drive means including a motor being operable to rotate the fastening assembly about the operative axis;

secondary power drive means including a motor being operable to move the fastening assembly relative to the base in the direction of the operative axis;

electronic control means for controlling at least the operation of the secondary power drive means, the electronic control means having user controls; and

at least one handle which is held by the user while operating the power tool,

wherein the user controls are located on the at least one handle to enable user operation of the secondary power drive means while holding the at least one handle.

The power tool according to the present invention includes an electronically controlled (secondary) power drive for moving, and in the case of a router, plunging the operative element to treat a work piece over a treatment depth from a face of the work piece. The electronic control means controlling the movement of the operative element have user controls located on the handle for the tool which the operator grips when operating the tool. This location allows a user accessible, safer, more convenient, and in some cases more ergonomic control of the tool during operation. Moreover, a user need not let go of the handle during operation of the tool to modify or adjust operation of the operative element, as such adjustments can be achieved through manipulation of the controls located on the handle of the tool.

The user control means located on the at least one handle can include further control means for controlling other functions of the power tool. These control means may or may not be linked to the electronic control means.

In some embodiments, the electronic control means also includes user control means located on the at least one handle for controlling the operation of the primary power drive means. A switch or control means controlling power functions of the tool can also be included in the at least one handle of the power tool. More preferably, the at least one handle includes a switch which locks on the power of the power tool.

In some embodiments, there is provided at least one user control on the at least one handle for fine adjustment of the movement of the operative means along the operational axis. Preferably, the user control means for fine adjustment of the movement of the operative means is connected to the electronic control means. In this respect, the at least one handle includes a control which allows low speed or fine control of the secondary power control means via the electronic control means. This particular control is useful for changing the zero surface depth calibration of the power tool.

In some embodiments, the user controls on the at least one handle includes a means for selecting an adjustment mode of the electronic control means and an adjustment controller for adjusting the parameters in that mode. The adjustment mode is preferably selected from at least one of the secondary power drive means, primary power drive means, rotation of the operative element, or plunging speed of the operative element.

The primary power drive means rotates the operative element at a rotating speed. In some embodiments, the rotating speed can be controlled by the electronic control means, preferably through user controls located on the at least one handle. It is further preferred that the rotating speed is adjustable to suit specifications of the operative element and the work piece.

Any number of arrangements of handles can be used for an operator to hold during operation of the power tool according to the present invention including two or more handles, one or more of the user controls for the electronic control means being located on one or more of the handles.

In some embodiments, the handle is located proximate to the primary power means. However, it is more preferable for the at least one handle to extend from the base of the power tool. Preferably, each handle is integrally formed with the base of the power tool.

It should be appreciated that the positioning of the handles on the base can provide a user with greater stability and control over the tool in comparison to when the handles extend from other locations on the tool. For example, in some configurations the handles can be attached to a housing which is movable mounted above the base, the housing moving along the operative axis during operation of the tool. When operating such tool, a user must compensate for and control axial movement of the handles along the operative axis in addition to the other parameters required for treating the work piece. In comparison, when the handles are attached to the base, the handles are stationary relative to the operative axis, and therefore afford greater stability and control of the tool when treating the work piece.

Any number of handles can extend from the base. In some embodiments, two or more handles extend from the base. Preferably, each of the handles is spaced apart about the perimeter of the base of the tool. More preferably, when the tool includes two handles, each handle extends from generally opposite locations on the base.

The powered plunging configuration provided by the secondary power drive can take a number of forms. In one embodiment, the hand held power tool includes an output shaft extending from the motor of the primary power drive means. The output shaft extends coaxially with the operative axis with the fastening assembly located at a distal end of the output shaft. In such a configuration, the secondary power drive means is preferably operatively associated with the primary power drive means so that operation of the secondary power drive means moves the primary power drive means and the fastening assembly relative to the base. This association can take many forms.

In one embodiment, the secondary power drive means includes a screw drive and a geared connection between the motor of the secondary power drive and the screw drive. This geared connection preferably includes a drive member located on an output shaft of the motor of the secondary power drive means and a driven member associated with the screw drive. The screw drive typically includes a threaded shaft fixed in position relative to the base. The driven member typically has a threaded bore for locating the driven member on the shaft so that rotation of the driven member about the shaft causes movement of the driven member along the shaft.

In some embodiments of the invention, the power tool further includes a housing which houses the primary power drive means and secondary power drive means, the housing being movable relative to the base in the direction of the operative axis. In such embodiments, movement of the driven member along the shaft can therefore result in movement of the primary drive means and the fastening assembly relative to the base. In this respect, the power tool can be configured to allow the driven member to engage the primary power drive means so as to move therewith relative to the base. The driven member may directly or indirectly engage the primary drive means.

In another embodiment, the hand held power tool includes an output shaft extending from the motor of the primary power drive means wherein the output shaft extends parallel to the operative axis. The drive shaft assembly extends parallel to the output shaft of the motor of the primary power drive means, and operatively connects the primary power drive means to the operative element. The drive shaft assembly is also adjustable in a direction of the operative axis to move the fastening assembly relative to the base with the secondary power drive means being operatively associated with the drive shaft assembly so that operation of the secondary power drive means adjusts the drive shaft assembly.

In some embodiments of the invention, the drive shaft assembly includes at least two elements that rotate about the operative axis and that move relative to each other in the direction of the operative axis to adjust the drive shaft assembly. In this embodiment, the drive shaft assembly can include a drive element in driving engagement with a driven element, and a sleeve within which the driven element rotates, the sleeve being connected to the secondary power drive means so that operation of the secondary power drive means moves the sleeve and the driven element in the direction of the operative axis. In this respect, the driven element is operatively associated with the fastening assembly and the secondary power drive means so that operation of the secondary power drive means moves the driven element relative to the drive element to move the fastening assembly relative to the base. The motor of the secondary power drive means preferably drives a threaded output shaft on which shaft is located a driven member having a threaded bore, the driven member is connected to the sleeve so that rotation of the output shaft moves the driven member along the threaded shaft and moves the sleeve with the driven element and fastening assembly relative to the base. More preferably, the output shaft from the motor of the primary power drive means is in driving engagement with the drive element of the drive shaft assembly so that rotation of the output shaft rotates the drive element.

In one form, the secondary power drive controls movement characteristics of the fastening assembly over the treatment depth. The movement characteristics include plunging speed and/or plunging force. The movement characteristics may be controllable by the electronic control means, a gearbox or both. The plunging force may also be controllable by the electronic control means, a gearbox or both. The gearbox may include a plurality of gears that are operable for providing respective movement characteristics settings. The gearbox may further include a means for mechanically selecting one of the gears and its respective movement characteristics setting. In addition, or alternatively, the power tool may include a means for electronically selecting one of the gears and its respective movement characteristics setting. The means for selecting the one of the gears may include a motorised gear selection mechanism.

The preferred form of hand held power tool is a router, and the preferred form of operative element is a router bit.

According to another aspect of the invention there is provided a microcontroller for use with a hand held power tool for use with an operative element to treat a work piece over a treatment depth from a face of the work piece. The power tool includes a base positionable in use adjacent the work piece; a fastening assembly for holding the operative element, the fastening assembly being rotatable about an operative axis, the fastening assembly being movable relative to the base in the direction of the operative axis; primary power drive means including a motor being operable to rotate the fastening assembly about the operative axis; secondary power drive means including a motor being operable to move the fastening assembly relative to the base in the direction of the operative axis; at least one handle which is held by the user while operating the power tool; and user controls located on the at least one handle to enable user operation of the secondary power drive means while holding the at least one handle. The microcontroller includes a processing unit and associated memory device for storing control logic to cause the microprocessor to receive control inputs from the user controls; and control operation of the secondary power drive means in accordance with the control inputs.

Preferably, the control logic further acts to cause the microprocessor to control operation of the primary power drive means in accordance within the control inputs.

The primary power drive means rotates the operative element at a rotating speed. The control logic preferably further acts to cause the microprocessor to control the rotating speed in accordance with the control inputs.

The control inputs may be indicative of user selection of an adjustment mode and user selection of parameters in that mode. In this case, the control logic may further act to cause the microprocessor to control operation of at least one of the secondary power drive means, primary power drive means, rotation of the operative element, or plunging speed of the operative element in response to user selection of the adjustment mode and parameters.

The control logic may further act to cause the microprocessor to adjust the rotating speed to suit specifications of the operative element and the work piece.

The secondary power drive may move the fastening assembly over the treatment depth at a plunging speed. In this case, the control logic may further act to cause the microprocessor to control the plunging speed in accordance with the control inputs

The control logic may further act to cause the microprocessor to adjust the plunging speed to suit specifications of the operative element and the work piece.

The secondary power drive includes a gearbox having a plurality of gears that are operable for providing respective plunging speed settings, and the power tool includes a means for electronically selecting one of the gears and its respective plunging speed setting. In this case, the control inputs act to cause the microprocessor to control the electronic selection of gears.

### BRIEF DESCRIPTION OF THE DRAWINGS

It will be convenient to hereinafter describe the invention in greater detail by reference to the accompany drawings which show two preferred embodiments of the invention. The particularity of the drawings and the related detailed description is not to be understood as superseding the generality of the preceding broad description of the invention.

FIG. 1 is a perspective view of a first preferred embodiment of a power tool according to the present invention.

FIG. 2 is further perspective view of the power tool shown in FIG. 1 having a portion of the housing removed to show the location of a primary power drive means, secondary power drive means, drive shaft assembly, fastening assembly and operative element.

FIG. 3 is a front elevational view of the power tool shown in FIG. 1 including cut out side views of each handle of the power tool.

FIG. 3a is a left hand side view of the left hand grip of the router shown in FIG. 3.

FIG. 3b is a right hand side view of the right hand grip of the router shown in FIG. 3.

FIG. 4 is a block diagram illustrating the connections between each of the elements of the power tool shown in FIG. 3.

FIG. 5 is a front elevational view of a second preferred embodiment of the power tool according to the present invention.

FIG. 5a is a left hand side view of the left hand grip of the router shown in FIG. 5.

FIG. 6 is a block diagram illustrating the connections between each of the elements of the power tool shown in FIG. 5.

FIG. 7 is a schematic diagram of the printed circuit board forming part of the control circuiting of the power tool shown in FIGS. 3 and 5.

FIG. 8 is a front elevational view of an alternative embodiment of the secondary power drive means of the power tool shown in FIG. 1 including a portion of the housing attached to the secondary power drive means and a two speed gearbox arrangement.

FIG. 9 is a side section view of the secondary power drive means shown in FIG. 8 illustrating components of the secondary power drive means including a two speed gearbox.

FIG. 10 is a side view of components of the secondary power drive means shown in FIG. 8.

### DETAILED DESCRIPTION

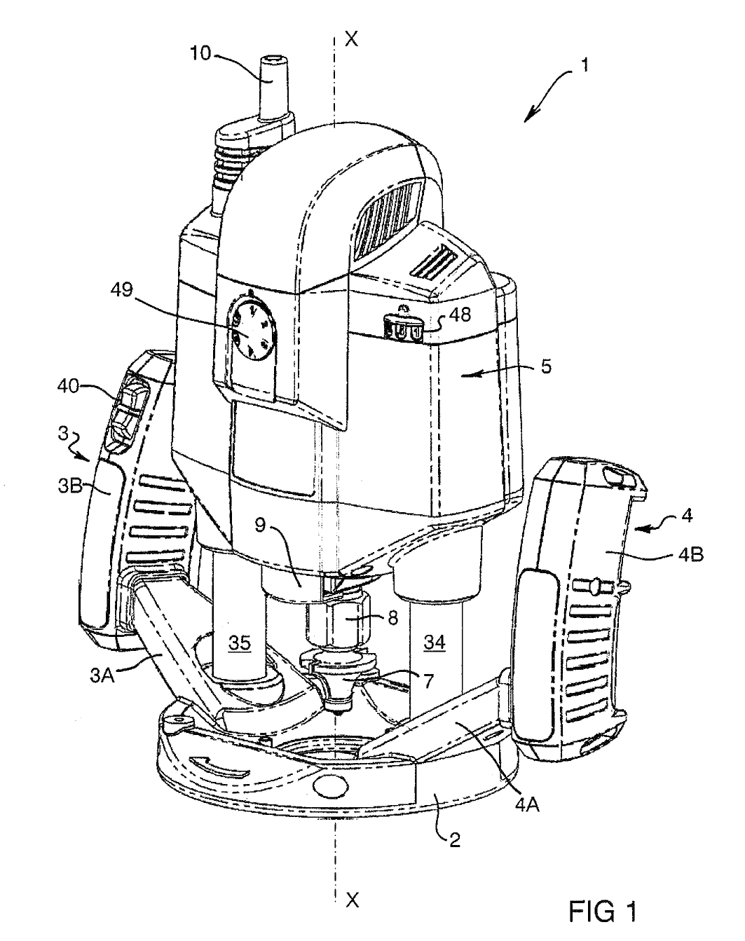

Referring to FIG. 1, there is illustrated a hand held router 1 which incorporates one preferred form of power tool according to the present invention. The router 1 includes a generally circular base 2 which in use, is positionable adjacent a work piece such as a timber panel (not shown) using a pair of handles 3, 4. Each of the handles 3, 4 include a trapezoidal shaped extension member 3A, 4A and a generally rectangular shaped hand grip 3B, 4B attached to the distal end thereof. Each of the extension members 3A, 4A extend outwardly from opposite sides of the perimeter of the base 2 at an upwardly angle relative to the base 2. The length of the connecting hand grips 3B, 4B extend perpendicularly to the length of each extension members 3A, 4A thereby providing a vertically orientated gripping region when the router 1 is used in the normal operational orientation, as shown in FIG. 1. Each of the hand grips 3B, 4B include a set of controls 40, 42, 44, 46 which will be described in greater detail later in the specification.

A pair of cylindrical columns 34, 35 extend from an upper surface of the base 2 from opposite sides of the base 2, adjacent to the location where the handles 3, 4 extend from the base 2. A housing arrangement 5 is supported above the base 2 on the columns 34, 35. The housing 5 encloses the operative components of the router 1 and is (in at least the illustrated embodiment) movable relative to its base 2 about columns 34, 35. It should however be appreciated that in some alternative embodiments, the router 1 could be configured with the housing 5 being stationary relative to the base 2. A cylindrical power conduit 10 extends from a top corner of the housing 5. As can be appreciated, the total length of the power conduit 10 has not been illustrated, and would normally extend through a length of cord ending with a power plug at its free end.

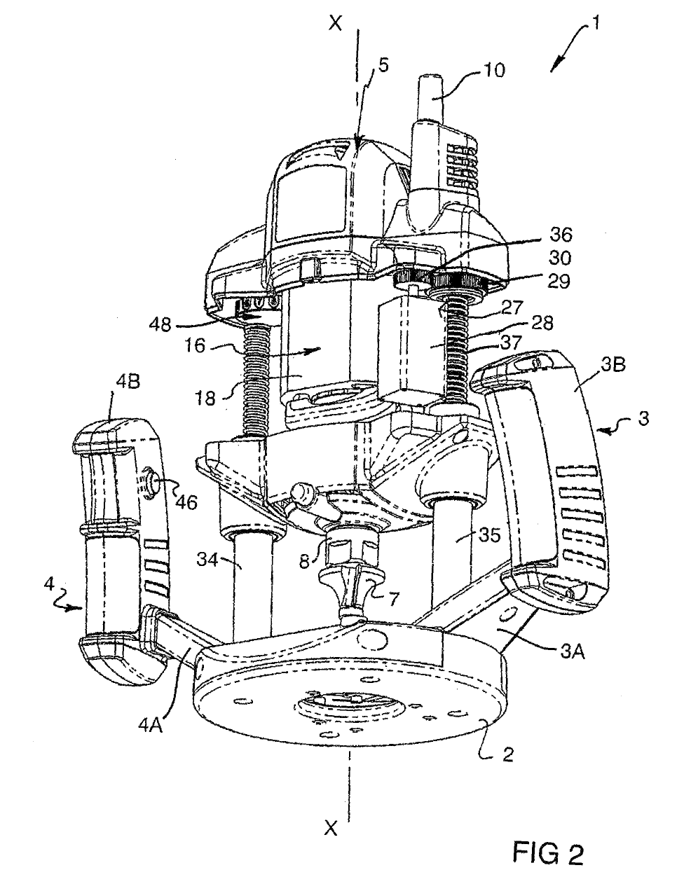

An operative element or router bit 7 for treating the face of a work piece is shown in a position spaced between the housing 5 and the base 2. The router bit 7 includes a fastening portion (not illustrated) which is fastened within and held by a fastening assembly or more specifically a collet 8 which extends out of the base of the housing 5. The router bit 7 can be secured within and removed from the collet 8 by actuation of spindle lock button 9, which is connected to an internal locking means (not illustrated) of the collet 8. In operation, the collet 8 and router bit 7 are rotated about an operative axis X-X by operation of a primary power drive means (16 in FIG. 2), and movable in the direction of the operative axis X-X by operation of a secondary power drive means (27 in FIG. 2). Each of the primary power drive means 16 and secondary power drive means 27 are enclosed within housing 5.

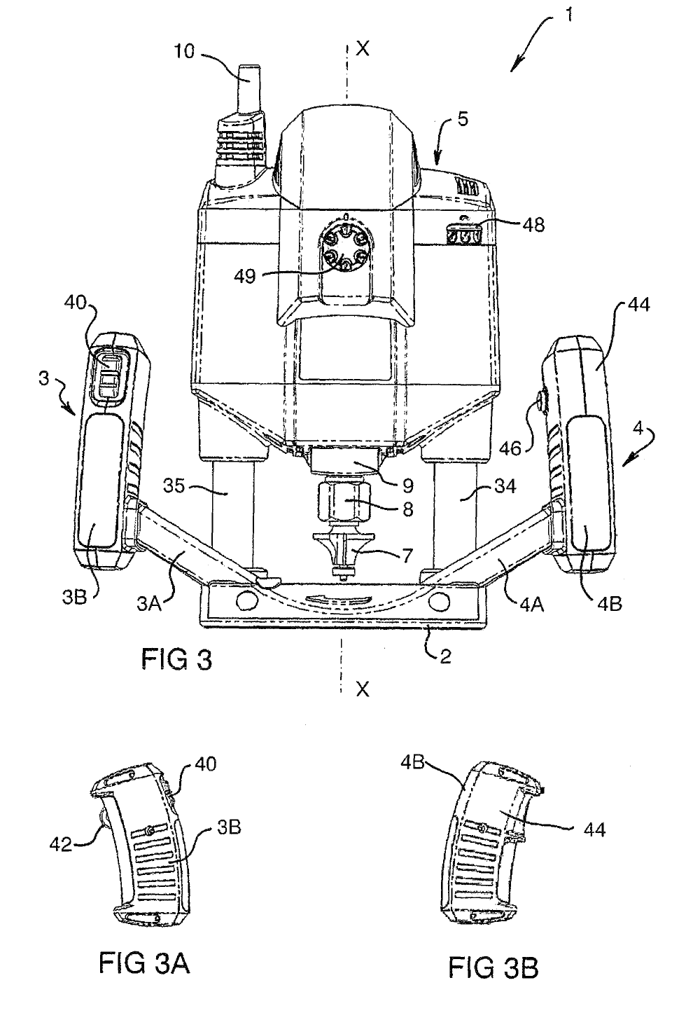

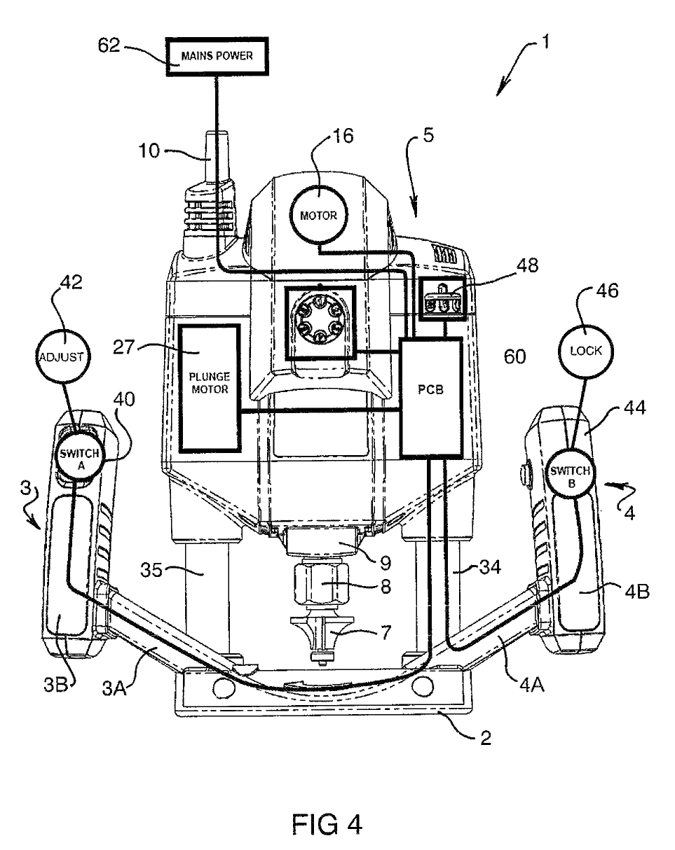

The primary power drive means 16, best illustrated in FIG. 2 and the schematic shown in FIG. 3, includes an electric motor having a rotor (not illustrated) and a stator 18. An output shaft (not illustrated) of the primary power drive means 16 extends from the rotor. The collet 8 is located at a free end of the output shaft for retaining a router bit 7. Rotation of the rotor causes rotation of the output shaft and therefore rotation of the router bit 7 about an operative axis X-X. As can be appreciated, the rotational speed of the collet 8 and router bit 7 can be controlled by controlling the speed of the primary power drive means 16. This is achieved through use of an electronic control means 60 (FIG. 4) and user controls 40, 42, 44, 46 on the handles 3, 4 as will be discussed in more detail later in the specification.

As illustrated in FIGS. 2 and 8 to 10, the housing 5 is movable relative to the base 2 by way of operation of a secondary power drive means 27. The secondary power drive means 27 illustrated includes a housing 28, a motor 26 with an output shaft 29 having a geared drive wheel 36 located thereon. The housing 5, primary power drive means 16, and attached collet 8 are mounted about a driven sprocket 30 mounted on a threaded shaft 37 extending from one of the columns 35. The driven sprocket 30 has a threaded bore 70, allowing the driven sprocket 30 to move along the length of the shaft 37, and thereby accordingly move the housing 5 and attachments. The driven sprocket 30 has a geared perimeter which interengages with an associated geared perimeter of the geared drive wheel 36. In operation, the geared drive wheel 36 drivingly engages the driven member 30 so that rotation of the geared drive wheel 36 causes the driven member 30 to move relative to the threaded shaft 37.

It is preferred that the motor 26 of the secondary power drive means 27 allow for fine controlled rotation of its output shaft 29. A sensor (not shown) may be included to measure steps of each rotation. A resolution of 200 increments per rotation may be suitable.

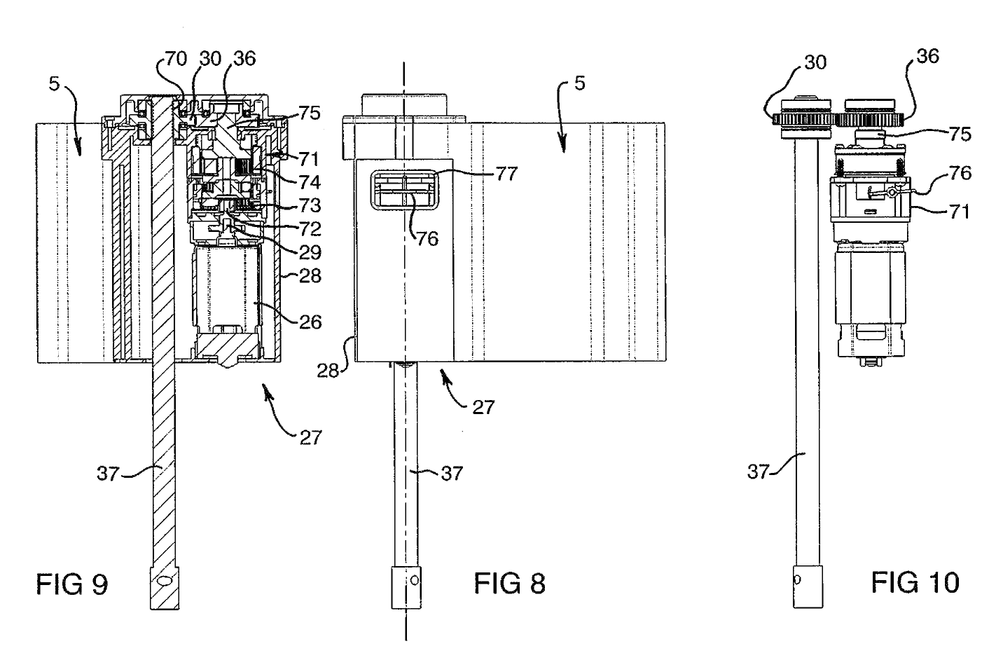

The embodiment of the secondary power drive means 27 illustrated in FIGS. 8 to 10 includes a two speed gearbox 71 provided between the motor 26 and the geared drive wheel 36. In this arrangement the output shaft 29 of the motor 26 is indirectly coupled to the geared drive wheel 36 via the two speed gearbox 27. The output shaft 29 is coupled to an input shaft 72 for the gearbox 71. The gearbox 71 has a first ratio gear 73 that is operable, when selected, for transmitting rotation of the motor output shaft 29 and the gearbox input shaft 72 into rotation of an output shaft 75 of the gearbox 71. The gearbox output shaft 75 is coupled to the drive wheel 36 such that rotation of the gearbox output shaft 75 causes rotation of the drive wheel 36, which as mentioned above, drives rotation of the driven member 30 and causes the driven member 30 to move relative to the threaded shaft 37. The first ratio gear 73 is configured so as to cause a relatively slow rate of rotation of the gearbox output shaft 75, the drive wheel 36 and the driven member 30. Thus, the first ratio gear 73 provides for a relatively slow rate of movement of the driven member 30 relative to the threaded shaft 37 for a given rate of rotation of the motor output shaft 29. By providing a relatively slow rate of movement of the driven member 30 relative to the threaded shaft 37 for a given rate of rotation of the motor output shaft 29, the first ratio gear 73 is suitable for selection when it is desired to have finer control of the plunging speed of the collet 108 and attached router bit 107. For example, when the router bit 107 is being plunged into a relatively delicate work piece finer control of the plunging speed may be appropriate. It will be appreciated that the first ratio gear 73 will also be operable for applying a relatively greater amount of torque in the gearbox output shaft 75. This greater amount of torque will result in a greater plunging force being applied to the collet 108 and attached router bit 107.

Similarly, the gearbox 71 has a second ratio gear 74 that is configured, when selected, for transmitting rotation of the motor output shaft 29 into a faster rate of rotation of the gearbox output shaft 75 and the drive wheel 36, which in turn, causes a faster rate of rotation of the driven member 30. The faster rotating driven member 30, in turn, moves relative to the threaded shaft 37 at a relatively faster rate. Thus, compared to the first ratio gear 73, the second ratio gear 74 provides for a relatively faster rate of movement of the driven member 30 relative to the threaded shaft 37 for a given rate of rotation of the motor output shaft 29. By providing a relatively faster rate of movement of the driven member 30 relative to the threaded shaft 37 for a given rate of rotation of the motor output shaft 29, the second ratio gear 74 is suitable for selection when finer control of the plunging speed of the collet 108 and attached router bit 107 is not required and instead a faster plunging speed is required. For example, when the router bit 107 is being plunged into a relatively course work piece, when the user is more experienced in the use of the router 1 or for some other reason, finer control of the plunging speed may not be appropriate or required and a faster plunging speed may be more appropriate or advantageous. It will be appreciated that the second ratio gear 74 will also be operable for applying a relatively lesser amount of torque in the gearbox output shaft 75 compared to the first ratio gear 73. This greater amount of torque will result in a greater plunging force being applied to the collet 108 and attached router bit 107.

As shown in FIG. 10, the two speed gearbox 71 includes a gear selection lever 76 which is accessible through an aperture 77 in the housing 28 of the secondary power drive means 27. The lever 76 is coupled to the gearbox 71 and is configured, when operated by hand, to mechanically select either the first ratio gear 73 or second ratio gear 74 as required. It is to be appreciated, however, that the router 1 may incorporate an electronically controlled means for selecting either the first ratio gear 73 or second ratio gear 74 which may be incorporated into other electronic control means for the router 1. The means for selecting the first ratio gear 73 or the second ration gear 74 may include a motorised gear selection mechanism (not shown). Also, while the embodiment of the gearbox 71 illustrated in FIGS. 8 to 10 incorporates only two ratio gears 73, 74, it is to be appreciated that any number of suitable gears may be utilised, for example three, four or more gears.

Operation of the secondary power drive means 27 results in movement of the driven member 30 relative to the threaded drive shaft 37, allowing the router bit 7 to be moved from a position above the base 2, as shown in FIGS. 1 and 2, to a position beneath the base 2. Moreover, as the position of the primary power drive means 16 is fixed relative to the housing 5, operation of the secondary power drive means 27 will cause corresponding movement of the housing 5 relative to the base 2 in the direction of the operative axis X-X.

Referring to FIGS. 1 and 3, there is shown the locations of a number of user controls 40, 42, 44, 46 on the housing 5 and handles 3, 4 of the router 1. As shown in FIG. 4, each of the user controls 40, 42, 44, 46 is connected to an electronic controller 60, which in turn is connected to and actuates the mains power 62, primary power drive means 16 and secondary power drive means 27 in response to operation of these user controls 40, 42, 44, 46.

The left hand grip 3B includes a pivot switch 40 located proximate to the distal or free end of the grip 3B. This location allows a user to actuate the switch 40 using the left thumb or a finger of the user's left hand. The pivot switch 40 is arranged to be moved upwardly to actuate one control setting and downwardly to actuate a second control setting in the electronic controller 60. In this embodiment, the pivot switch 40 actuates operation of the second power drive means 27 through the electronic controller 60. Accordingly, movement of the pivot switch 40 upwardly operates the second power drive means 27 to move the collet 8 and router bit 7 upwardly in the direction of the X-X axis, and movement of the pivot switch 40 downwardly in the direction of the X-X axis, operates the second power drive means 27 to move the collet 8 and router bit 7 upwardly.

As shown in FIG. 3a, the left hand grip 3B can also include a roller switch 42 which can be actuated by the index or middle finger of a user's left hand. In this embodiment, the roller switch 42 controls the plunge depth of the router bit 7 within a preselected depth range. The roller switch 42 can be used in conjunction with the pivot switch 40 to lower the router bit 7 to any depth within the depth range of the router, which is typically 70 mm.

As best seen in FIG. 3b, the right hand grip 4B includes a power trigger 44 for switching power to the primary power drive means 16. Depression of the power trigger 44 actuates the controller 60 to switch power on to the primary power drive, thereby powering the motor and thereby causing the collet 8 and router bit 7 to rotate. The power trigger 44 is preferably actuated by the index and/or middle finger of a user's right hand. In some forms, the power trigger 44 can provide different levels of power to the primary power drive means 16 depending on how far the trigger 44 is depressed and therefore controls the speed of rotation of the collet 8 and router bit 7.

The right hand grip 4B also includes a power locking button 46 which when depressed locks the power on to the primary power drive means 16. Thereafter, power to the primary power drive means 16 can only be unlocked or turned off by pressing the power trigger 44 which releases the power locking button 46, or of course turning the power of at the source (mains 62, socket or the like). The power locking button 46 is generally used by a user when the user wishes to operate the power the rotation of the router bit 7 for an extended length of time, and/or if their finger is becoming tired depressing the power trigger 44. The button 46 can be actuated by a finger or thumb of a user's right hand.

Referring to FIG. 3, the housing 5 includes a number of controls 48, 49 on the front facia of the housing 5.

Located at the upper right hand corner of the front of the housing 5 is a depth dial 48. The depth dial 48 controls the plunge depth of the router bit 7 within a preselected depth range. For the illustrated embodiment the depth range is 70 mm. The depth dial 48 has incremental settings of 0.5, 1, 2, 3, 4, 5, 6, 8, 10, 15, 20, 25 mm. The depth dial 48 can be used in conjunction with the pivot switch 40 to lower the router bit 7 to any depth within the depth range.

For example, when the depth dial 48 is set to a high setting, for instance 10 mm or 15 mm, the router bit 7 is enabled to move a 10 mm range at the predetermined depth. At the other extreme, the depth dial 48 could be set to a low setting, for instance 1 mm or 0.5 mm position and therefore only allow a very small movement range at a selected depth. Moreover, in selected embodiments, when set at this setting, movement of the router bit 7 along the X-X axis actuated by pivot switch 40 is comparatively low.

A low depth dial 48 setting is useful when making an accurate zero surface depth calibration. In this respect, adjustment can be made by lowering the router bit 7 using the pivot switch 40 on the left hand handle 3 until the top of the router bit 7 is close to the work surface. Adjustment can then be made by setting the depth dial 48 to the 1 mm or 0.5 mm position and then using the pivot switch 40 to fine adjust the zero surface setting of the router bit 7.

Still referring to FIG. 3, the housing 5 further includes a speed control dial 49 at the centre of the front facia of the housing 5. The speed control dial 49 sets the speed of the primary power drive means 16 to a particular setting or range of speeds. In the illustrated embodiment, the speed control dial 49 adjusts the speed of the primary power drive means 16 between 10,000 rpm to 20,000 rpm. Therefore, when the trigger switch 44 is depressed, the router bit 7 is rotated at or within a set speed range determined by the setting of the speed control dial 49.

FIG. 4 provides a block diagram representation of the main components of the router 1 and the connections between these components and an electronic controller in the form of a microcontroller mounted on a printed control board (PCB) 60. Each of the primary drive means 16, secondary drive means 27, mains power 62, depth dial 48, speed control dial 49, pivot switch 40, roller switch 42, power trigger 44 and power lock button 46 are connected to the microcontroller 60. Actuation of any one or more of the depth dial 48, speed control dial 49, pivot switch 40, roller switch 42, power trigger 44 and power lock button 46 triggers an action in the microcontroller 60, which in turn actuates the appropriate response or action in one of the drive means 16, secondary drive means 27, or mains power 62. For example, when the power trigger 44 is actuated, the microcontroller 60 responds to this actuation by appropriately starting the motor of the primary drive means 16.

In order to include control switches such as the pivot switch 40, roller switch 42, power trigger 44 and power lock button 46 in the handles 3, 4 of the router 1, it is necessary to create a clear path of conduit through the router 1 structure from each of the handles 3, 4 to the housing 5. In this respect, most past configurations of routers have included the control switches in the housing in order to keep the switches in close proximity to the components that these switches are connected and control. The close proximity to components also simplifies the wiring connections between switches and components, but can limit the accessibility and ease of use of such controls. In comparison, the control switches 40, 42, 44, 46 of the illustrated embodiment have been located in a much more accessible location, on the handles 3, 4 of the router 1. As schematically illustrated in FIG. 4, this has necessitated the inclusion of specific pathways or conduits between the housing 5 and handles 3, 4, through column 34 and through the base 2 and extension members 3A, 4A to create the connections between components, controllers and switches in the illustrated embodiment of the present invention.

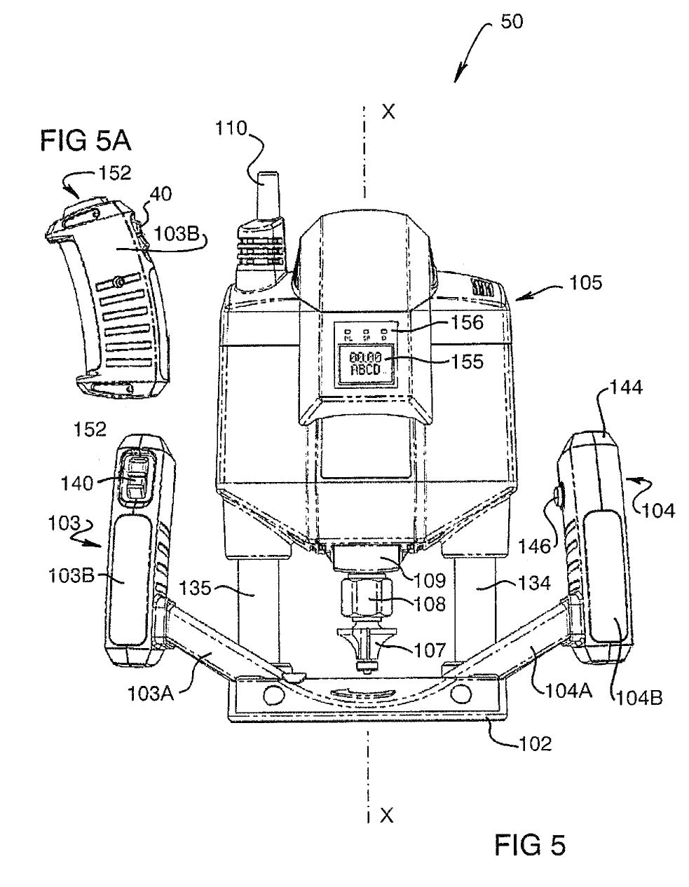

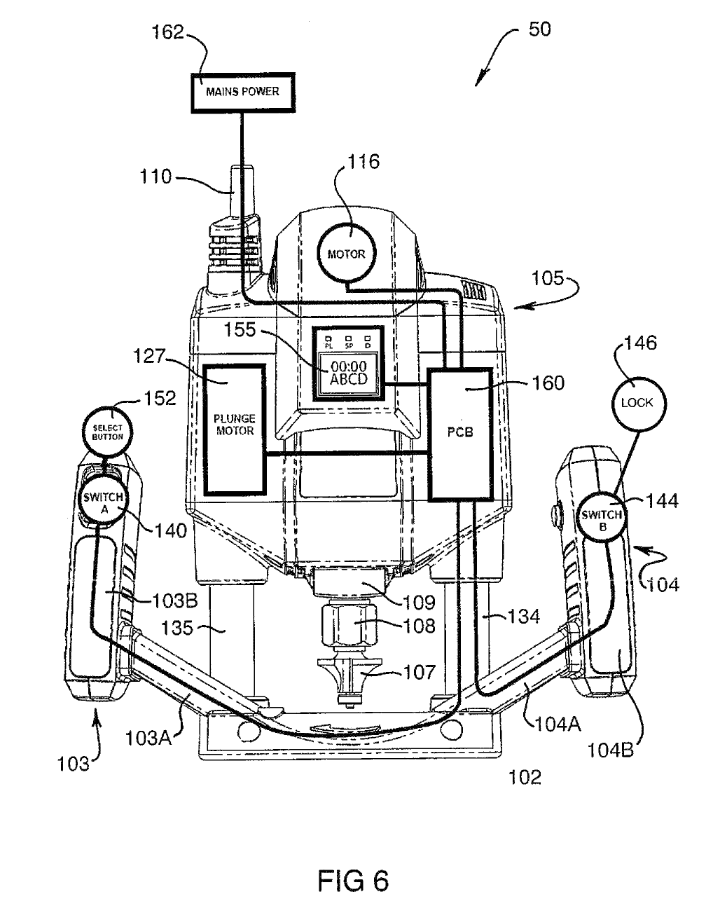

FIGS. 5 and 6 illustrates router 50 incorporating another embodiment of the present invention. The router 50 has substantially all the same elements as the previously described router 1, with the exception of the configuration of the control means 152 provided on the handle 103 and display 155, 156 on housing 105. Due to this similarity, each like element has been given the same numerical designation with the addition of 100, and it should be understood that the foregoing description of these like elements of router 1 is equally applicable to the elements disclosed in FIGS. 5 and 6 for router 50.

As shown in FIG. 5a, the left hand grip 103B of the router 50 includes an upper mode switch 152 which can be actuated by the users left hand thumb. The mode switch 152 is used to select an adjustment mode in which the pivot switch 140 can be used to adjust one or more parameters in that mode. In the illustrated router 50, the mode switch 152 is connected to a microcontroller mounted on a PCB 160 in FIG. 6 which controls the functions of each of the primary power drive means 116, secondary power drive means 127, rotation speed of the collet 108 and router bit 107, plunging speed of the collet 108 and attached router bit 107. Referring to FIG. 6, it can be seen that actuation of the mode switch 152 causes the microcontroller 160 to be set into a particular mode, say for example primary drive means 116 speed. This mode is indicated on the LED array 156 located on the housing 5 and will be displayed on the LCD display screen 155, with the graphics on the screen 155 changing to show the parameters for that particular mode. The pivot switch 140 can then be used to adjust the parameters shown on the screen 155. Similar adjustment can be made for controlling the secondary power drive means 127 (plunge speed, depth, zero depth calibration or the like).

The display screen 155 and control switches or buttons 140, 144, 146, 152 can be used in some embodiments for accessing other electronic functions of the router 50 such as metric/imperial conversions, languages, calibration functions or the like.

It should be appreciated that the described router 1 and 50 utilise a secondary power drive means 27, 127 to move the router bit 7, 107 relative to the base 2, 102 which is controlled from a hand grip control switch 40, 140. The combination of these features makes plunging the router bit 7, 107 to the required depth easier and allows the operator to plunge with greater precision than existing plunging routers. It should also be appreciated that the embodiments of the invention in which the handles 3, 4, 103, 104 are attached to the base 2, 102 facilitates vision of the router bit 107, as this configuration allows a user to grip the router 1, 50 at the base 2, 102 rather than at a more upwardly position proximate to the housing 5, 105, which can in some configurations of router partially obscure the operators line of sight to the router bit 7, 107.

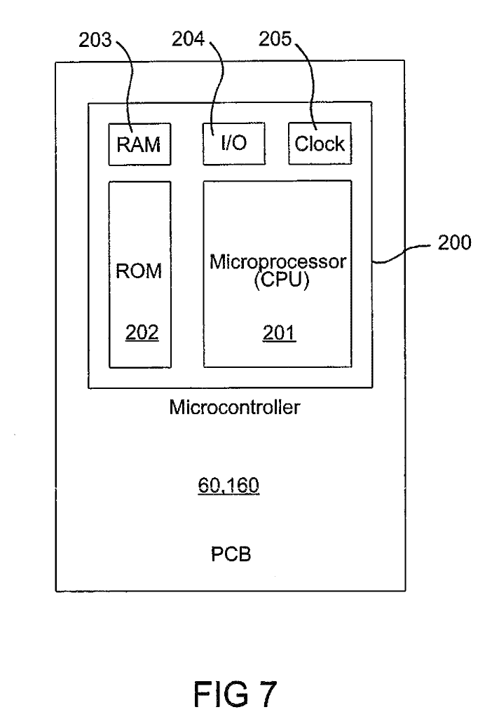

FIG. 7 is a schematic diagram of the microcontroller 200 mounted to the PCB 60 and the PCB 160 shown respectively in FIGS. 4 and 6. The microcontroller 200 includes central processing unit (CPU) 201, a non-volatile memory device 202 for storing control logic to cause the microcontroller to execute the functionality described herein, a volatile memory device 203 for temporarily storing data and control signals input to and output from the CPU 201, an input/output (I/O) control unit 203 and a clock unit 204.

In another embodiment, the invention may be implemented primarily in hardware using, for example, hardware components such as application specific integrated circuits (ASICs). Implementation of the necessary hardware components to perform the functionality described herein will be apparent to persons skilled in the relevant art(s).

In yet another embodiment, the invention may be implemented using a combination of both hardware and software.

Those skilled in the art will appreciate that the invention described herein is susceptible to variations and modifications other than those specifically described. It is understood that the invention includes all such variations and modifications which fall within the spirit and scope.

Future patent applications may be filed in Australia or overseas on the basis of or claiming priority from the present application. It is to be understood that the following provisional claims are provided by way of example only, and are not intended to limit the scope of what may be claimed in any such future application. Features may be added to or omitted from the provisional claims at a later date so as to further define or re-define the invention or inventions.

1. A hand held power tool for use with an operative element to treat a work piece over a treatment depth from a face of the work piece, the power tool including:
a base positionable in use adjacent the work piece;
a fastening assembly for holding the operative element, the fastening assembly being, rotatable about an operative axis, the fastening assembly being movable relative to the base in the direction of the operative axis; primary power drive means including a motor being operable to rotate the fastening assembly about the operative axis:
secondary power drive means including a motor being operable to move the fastening assembly relative to the base in the direction of the operative axis;
electronic control means for controlling at least the operation of the secondary power drive means, the electronic control means having associated user controls; and
at least one handle which is held by the user while operating the power tool, wherein the user controls are located on the at least one handle to enable user operation of the secondary power drive means while holding the at least one handle.

2. The hand held power tool according to claim 1, wherein the electronic control means also controls the operation of the primary power drive means, and the associated user controls are located on the at least one handle.

3. The hand held power tool according claim 1, wherein the primary power drive means rotates the operative element at a rotating speed, said rotating speed being controlled by user controls located on the at least one handle.

4. The hand held power tool according to claim 1, wherein the user controls located on the at least one handle further include fine or low speed control of the secondary power means.

5. The hand held power tool according to claim 1, wherein the user controls located on the at least one handle further including a means for selecting an adjustment mode of the electronic control means and an adjustment controller for adjusting the parameters in that mode.

6. The hand held power tool according to claim 5, wherein the adjustment mode is selected from at least one of the secondary power drive means, primary power drive means, rotation of the operative element, or plunging speed of the operative element.

7. The hand held power tool according to claim 1, including two or more handles, one or more of the user controls for the electronic control means being located on one or more of the handles.

8. The hand held power tool according to claim 1, wherein the at least one handle extends from the base of the power tool.

9. The hand held power tool according to claim 8, wherein the at least one handle is integrally formed with the base of the power tool.

10. (canceled)

11. The hand held power tool according to claim 8, including a pair of handles, each handle extending from generally opposite locations on the base.

12. The hand held power tool according to claim 1, wherein the secondary power drive means is operatively associated with the primary power drive means so that operation of the secondary power drive means moves the primary power drive means and the fastening assembly relative to the base.

13. (canceled)

14. The hand held power tool according to claim 1, wherein the secondary power drive means includes a screw drive and a geared connection between the motor of the secondary power drive and the screw drive, the geared connection includes a drive member located on an output shaft of the motor of the secondary power drive means and a driven member associated with the screw drive, the screw drive including a threaded shaft fixed in position relative to the base, and the driven member having a threaded bore for locating the driven member on the shaft so that rotation of the driven member about the shaft causes movement of the driven member along the shaft.

15. The hand held power tool according to claim 14, wherein the movement of the driven member along the shaft results in movement of the primary drive means and the fastening assembly relative to the base.

16-17. (canceled)

18. The hand held power tool according to claim 1, including an output shaft which extends from the motor of the primary power drive means and extends parallel to the operative axis and a drive shaft assembly extending parallel to the output shaft of the motor of the primary power drive means, wherein the drive shaft assembly operatively connects the primary power drive means to the operative element, and wherein the secondary power drive means is operatively associated with the drive shaft assembly so that operation of the secondary power drive means adjusts the drive shaft assembly.

19. The hand held power tool according to claim 18, wherein the drive shaft assembly includes a drive element in driving engagement with a driven element, and a sleeve within which the driven element rotates, the sleeve being connected to the secondary power drive means so that operation of the secondary power drive means moves the sleeve and the driven element in the direction of the operative axis.

20. The hand held power tool according to claim 19, wherein the motor of the secondary power drive means drives a threaded output shaft on which shaft is located a driven member having a threaded bore, the driven member is connected to the sleeve so that rotation of the output shaft moves the driven member along the threaded shaft and moves the sleeve with the driven element and fastening assembly relative to the base.

21. The hand held power tool according to claim 20, wherein the output shaft from the motor of the primary power drive means is in driving engagement with the drive element of the drive shaft assembly so that rotation of the output shaft rotates the drive element.

22. The hand held power tool according to claim 21, wherein the rotating speed is adjustable to suit specifications of the operative element and the work piece.

23. The hand held power tool according to claim 1, wherein the secondary power drive controls movement characteristics of the fastening assembly over the treatment depth.

24-31. (canceled)

32. The hand held power tool according to claim 1, wherein the power tool is a router and the operative element is a router bit.

33. A microcontroller for use with a hand held power tool for use with an operative element to treat a work piece over a treatment depth from a face of the work piece, the power tool including:
a base positionable in use adjacent the work piece;
a fastening assembly for holding the operative element, the fastening assembly being rotatable about an operative axis, the fastening assembly being movable relative to the base in the direction of the operative axis;
primary power drive means including a motor being operable to rotate the fastening assembly about the operative axis;
secondary power drive means including a motor being operable to move the fastening assembly relative to the base in the direction of the operative axis;
at least one handle which is held by the user while operating the power tool; and
user controls located on the at least one handle to enable user operation of the secondary power drive means while holding the at least one handle, the microcontroller including a processing unit and associated memory device for storing control logic to cause the microprocessor to: receive control inputs from the user controls; and control operation of the secondary power drive means in accordance with the control inputs.

34. The microcontroller according to claim 33, wherein the control logic further acts to cause the microprocessor to: control operation of the primary power drive means in accordance within the control inputs.

35. The microcontroller according to claim 33, wherein the primary power drive means rotates the operative element at a rotating speed, and wherein the control logic further acts to cause the microprocessor to: control the rotating speed in accordance with the control inputs.

36. The microcontroller according to claim 33, wherein the control inputs are indicative of user selection of an adjustment mode and user selection of parameters in that mode and wherein the control logic further acts to cause the microprocessor to: control operation of at least one of the secondary power drive means, primary power drive means, rotation of the operative element, or plunging speed of the operative element in response to user selection of the adjustment mode and parameters.

37. The microcontroller according to claim 35, wherein the control logic further acts to cause the microprocessor to: adjust the rotating speed to suit specifications of the operative element and the work piece.

38. The microcontroller according to claim 33, wherein the secondary power drive moves the fastening assembly over the treatment depth at a plunging speed and wherein the control logic further acts to cause the microprocessor to: control the plunging speed in accordance with the control inputs.

39. The microcontroller according to claim 33, wherein the control logic further acts to cause the microprocessor to: adjust the plunging speed to suit specifications of the operative element and the work piece.

40. The microcontroller according to claim 33, wherein the secondary power drive includes a gearbox having a plurality of gears that are operable for providing respective plunging speed settings, and wherein the power tool includes a means for electronically selecting one of the gears and its respective plunging speed setting, and wherein the control inputs act to cause the microprocessor to: control the electronic selection of gears.
